(19) United States
(12) Patent Application Publication
(10) Pub. No.: US 2007/0125215 A1
(43) Pub. Date: Jun. 7, 2007

(54) Apparatus for aligning a punch with a target area and method for doing the same

(76) Inventor: Robert Exman, Woodstock, OH (US)

Correspondence Address: DINSMORE & SHOHL LLP;One Dayton Centre, Suite 1300, One South Main Street, Dayton, OH, 45402-2023, US

(21) Appl. No.: 11/291,152

(22) Filed: Dec. 1, 2005

(51) Int. Cl. B26D 5/08

(52) U.S. Cl. 83/523; 83/622

(57) ABSTRACT

An apparatus for aligning a punch with a target area includes a body, a receptacle disposed within the body, a receptacle latitudinal indicator disposed on the body such that it is aligned with the latitudinal center of the receptacle, and a receptacle longitudinal indicator disposed on the body such that it is aligned with the longitudinal center of the receptacle. The receptacle may be configured to receive a punch or die. The receptacle latitudinal indicator is configured to identify the latitudinal center of the receptacle, and the receptacle longitudinal indicator is configured to identify the longitudinal center of the receptacle.

### FIELD OF THE INVENTION

The present invention generally relates to apparatuses and methods for punching and/or cutting holes in items. More particularly, the present invention relates to an apparatus and method for aligning a punch for punching and/or cutting holes in an object such as a wall of an electrical box in order to run electrical conduit or conductor through the hole.

### BACKGROUND OF THE INVENTION

Punches and/or other cutting devices used to punch and/or cut holes within an object such as a wall of an electrical enclosure or box are well known in the art. Holes are cut within the wall(s) of an electrical enclosure(s) such that a conduit and/or conductor may be run into the electrical enclosure. Generally, the wall of an electrical enclosure is fabricated from sheet metal such as steel.

Referring to FIG. 1, an exemplary embodiment of a conventional punch device is shown as 10. Punch device 10 may include a punch 12, a die 14, and a draw stud 16. A punch stud hole 13 is disposed within punch 12, and a die stud hole 15 is disposed in die 15 coaxially with punch hole 13. Such holes are configured to receive and engage draw stud 16 (e.g., threadingly engage) such that when draw stud 16 is actuated it may draw punch 12 toward and into die 14. Draw stud 16 may be actuated by a variety of conventional means such as a hexagonal head 18 manually operated by an operator (e.g., using a wrench) or a hydraulic driver (not shown).

As an example, in operation, a target sheet 1 such as a wall of an electrical enclosure may include a target latitudinal center indicator 2 that marks or identifies the position of the latitudinal center of an aperture desired to be punched from target sheet 1. Target sheet 1 may also include a target longitudinal center indicator 3 that marks or identifies the position of the longitudinal center of the aperture that is desired to be punched from target sheet 1. The intersection of target latitudinal and longitudinal center indicators 2 and 3, respectively, is aligned with the geometric center of the desired aperture.

In order to punch out the desired hole from target sheet 1, a pilot hole 6 is drilled at geometric center (which is the intersection of latitudinal or longitudinal center indicators 2 and 3) of a size sufficient enough to permit draw stud 16 to fit through it. Punch 12 and die 14 are positioned on opposite sides of target sheet 1 and aligned with the pilot hole. Draw stud 16 is inserted through die hole 15, pilot hole 6, and punch hole 13. An operator turns draw stud 16 such that it draws punch 12 through target sheet 1 and into die 14, cutting or punching a hole through target sheet 1.

Generally, pilot hole 6 is sized such that it is larger than draw stud 16, thus permitting punch 12 and die 14 to move along target sheet 1. Such movement of punch 12 and die 14 along target sheet 1 may permit punch 12 to punch an aperture in target sheet 1 that is not exactly at the desired location, i.e., misaligned or off-center. The misaligned aperture in the target sheet (e.g., wall of an electrical enclosure) may cause the hole to be misaligned with pre-installed electrical conduits, thus causing the electrical enclosure to be discarded and wasting time and money.

Some conventional dies have placed four lines on its outer surface, wherein each line is spaced 90 degrees apart around its peripheral edge or circumference. Such lines enable the operator to align them with the target latitudinal and longitudinal center indicators found on target sheet 1 to attempt to align punch 12 and die 14 in the exact, desired location along target sheet 1 before punching the desired aperture. However, such lines are faint and hard to see. In addition, they generally are along a vertical plane, which makes them even harder to see and align with the target latitudinal and longitudinal center indicators that are typically along a horizontal plane.

Accordingly, there is a need for an improved alignment apparatus and method for aligning punch and/or cutting devices.

### SUMMARY OF THE INVENTION

Accordingly, the present invention is intended to address and obviate problems and shortcomings and otherwise improve previous alignment devices and methods for punches.

One exemplary embodiment of the present invention is an apparatus for aligning a punch with a target area. The alignment apparatus includes a body, a receptacle disposed within the body, a receptacle latitudinal indicator disposed on the body such that it is aligned with the latitudinal center of the receptacle, and a receptacle longitudinal indicator disposed on the body such that it is aligned with the longitudinal center of the receptacle. The receptacle is configured to receive a punch or die. The receptacle latitudinal indicator is configured to identify the latitudinal center of the receptacle, and the receptacle longitudinal indicator is configured to identify the longitudinal center of the receptacle.

Another exemplary embodiment of the present invention is an apparatus for aligning a punch with a target aperture location to be punched within a sheet, including a body, a receptacle disposed within the body and configured to receive a punch or die, a first receptacle indicator aligned with and indicating the latitudinal center of the receptacle, and a second receptacle indicator aligned with and indicating the longitudinal center of the receptacle.

Still another exemplary embodiment of the present invention is an apparatus for determining the center of a conduit. The apparatus includes a body, a receptacle disposed within the body and configured to receive an end of a conduit, a receptacle latitudinal indicator disposed on the body such that it is aligned with the latitudinal center of the receptacle, and a receptacle longitudinal indicator disposed on the body such that it is aligned with the longitudinal center of the receptacle. The receptacle latitudinal and longitudinal indicators are configured to identify the geometric center of a conduit received within the receptacle.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a schematic representation of an exemplary embodiment of a conventional punch and die set;

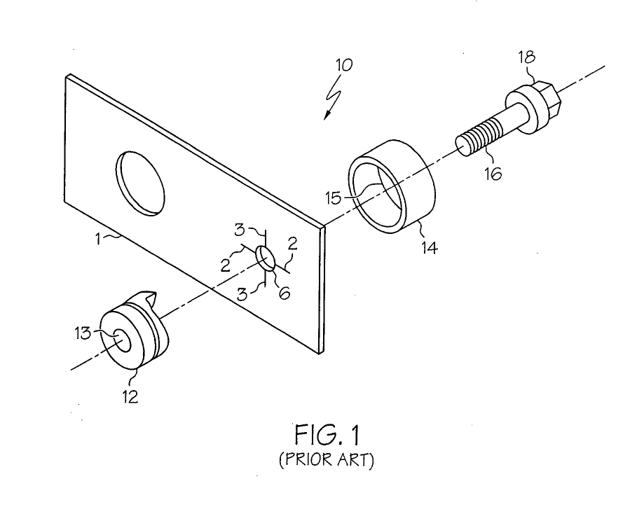

FIG. 2 is a top plan view of an exemplary embodiment of the alignment apparatus according to the present invention;

FIG. 3 is a side elevational view of the exemplary embodiment of the alignment apparatus shown in FIG. 2;

FIG. 4 is a schematic representation of the alignment apparatus shown in FIG. 2 positioned over a target sheet and aligned with target latitudinal and longitudinal indicators;

FIG. 5 is a side elevational view of the alignment apparatus and target sheet shown in FIG. 4 and a conventional punch and die set;

FIG. 6 is a top plan view of another exemplary embodiment of the apparatus according to the present invention; and

FIG. 7 is a side elevational view of the exemplary embodiment of the alignment apparatus shown in FIG. 4.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various exemplary embodiments of the invention, examples of which are illustrated in the accompanying drawings, wherein like numerals indicate similar elements throughout the views.

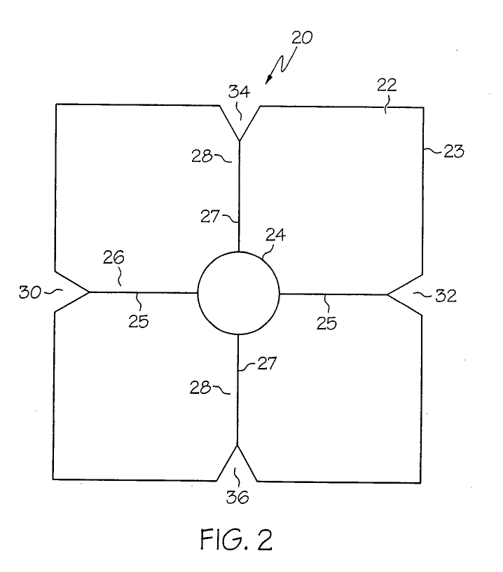

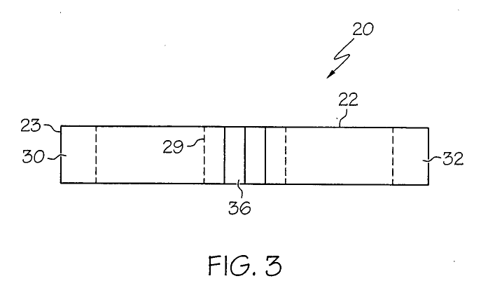

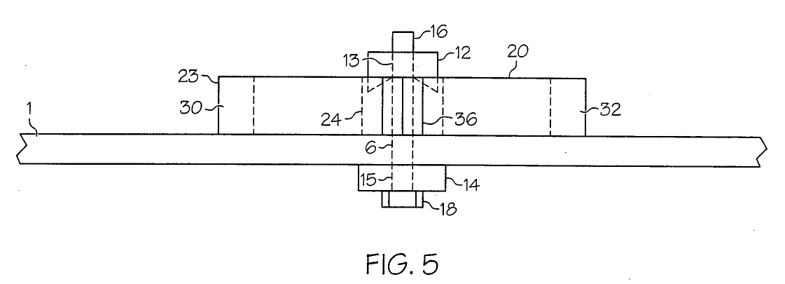

In one exemplary embodiment, the present invention provides apparatuses and methods to help properly align and/or position a punch and/or cutting tool along an object or sheet such as a wall of an electrical enclosure in order to punch or cut a hole within the enclosure at the desired location. Referring to FIGS. 2-5, an exemplary embodiment of an alignment apparatus of the present invention is shown as 20. Alignment apparatus 20 includes a body 22 that has a receptacle 24 disposed within body 22. Body 22 may also comprise a latitudinal center indicator 26 and a longitudinal center indicator 28 disposed along body 22. Such an alignment apparatus may be used with a conventional punch and die set, which for example may contain a punch 12, a die 14, and a draw stud 16 having a hexagonal head 18 as shown in FIG. 5.

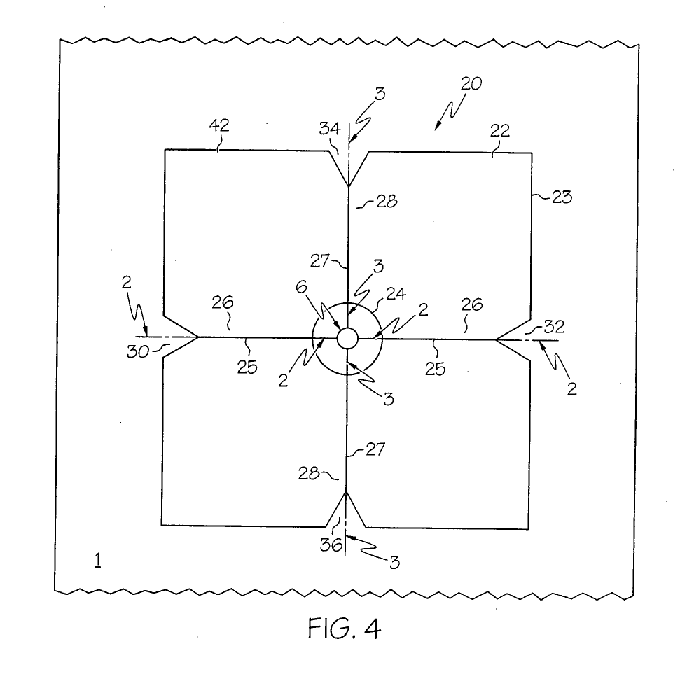

Body 22 may comprise any shape and/or size without departing from the spirit and scope of the present invention. In this exemplary embodiment, body 22 has a rectangular shape such as a square-shape. Additionally, body 22 may be fabricated from a variety of materials, including but not limited to metal, wood, composites, plastics (e.g., polymers), or combinations thereof. In one exemplary embodiment, body 22 is fabricated from a clear acrylic sheet such as ACRYLITE, commercially available from CYRO Industries. The clear plastic used for body 22 may assist an operator in aligning alignment apparatus 20 by enabling the operator to see a target sheet (e.g., target sheet 1, FIG. 4) and its alignment indicators (e.g., target latitudinal and longitudinal center lines 2 and 3, FIG. 4) through body 22, which assists the operator in aligning latitudinal and longitudinal center indicators 26 and 28 of alignment apparatus 20 with the latitudinal and longitudinal center lines 2 and 3 of target sheet 1. Thus, such alignment ensures punch 12 and die 14 are aligned at the desired location along target sheet 1 to punch (or cut) an aperture from target sheet 1.

In the exemplary embodiment shown in FIGS. 2-5, receptacle 24 is configured such that it is disposed completely through body 22. Receptacle 24 may be sized such that punch 12 may slide into receptacle 24 such that an operator may manipulate alignment apparatus 20 in order to align and hold punch 12 and die 14 at a desired aperture location along target sheet 1 as shown in FIGS. 4 and 5. Punch 12 slides through receptacle 24 as the punch punches (or cuts) an aperture through target sheet 1.

In another exemplary embodiment, alignment apparatus 20 is configured such that the receptacle is disposed completely through body 22 and sized such that die 14, rather than punch 12, may slide into the receptacle. The receptacle is sized such that die 14 may move through it until die 14 abuts against target sheet 1 while punch 12 punches (or cuts) an aperture through target sheet 1. Thus, alignment apparatus 20 may be positioned on the die-side of target sheet 1 rather than the punch-side of target sheet 1. Such a configuration permits an operator to move, align, and hold the die at a desired aperture location along target sheet 1 rather than punch 12.

However, it should also be understood that receptacle 24 may be sized such that both punch 12 and die 14 may be capable of fitting into and/or moving through receptacle 24. In another exemplary embodiment, receptacle 24 may be configured such that it is only partially disposed through body 22. In such an embodiment, punch 12 may, as it is drawn into die 14, punch through both body 22 and target sheet 1. In still another exemplary embodiment, receptacle 24 may be configured such that it comprises a mark indicating its location on body 22 in order to align die 12 or punch 14 with the marked receptacle 24 on body 22.

Referring back to the exemplary embodiment shown in FIGS. 2-5, body 22 may also comprise a receptacle latitudinal center indicator 26 and a receptacle longitudinal center indicator 28, marking and/or identifying the latitudinal center and the longitudinal center of receptacle 24, respectively. The intersection of the latitudinal and longitudinal centers define the geometric center (not shown) of receptacle 24. As shown in FIG. 2, receptacle latitudinal center indicator 26 comprises a line 25 disposed in a latitudinal orientation along body 22, and longitudinal center indicator 28 comprises a line 27 disposed in a longitudinal orientation along body 22 perpendicular to line 25. The intersection of lines 25 and 27 (i.e., receptacle latitudinal and longitudinal center indicators 26 and 28) is located at the geometric center (not shown) of receptacle 24. Such perpendicular lines 25 and 27 optionally create a visual appearance of cross hairs similar to what is used for aiming or targeting. In one exemplary embodiment, the latitudinal and longitudinal center lines 25 and 27 are scored or etched into body 22.

Receptacle latitudinal and longitudinal center indicators 26 and 28, respectively, may also comprise notches disposed within the body's (22) peripheral edge 23 and aligned with latitudinal and longitudinal center lines 25 and 27, respectively. As shown in FIG. 2, receptacle latitudinal center indicator 26 comprises a latitudinal center line 25 and first and second latitudinal notches 30 and 32, respectively, positioned such that the apex of notches 30 and 32 are aligned with latitudinal center line 25 and thus the latitudinal center of receptacle 24. FIG. 2 also shows receptacle longitudinal center indicator 28 comprising a longitudinal center line 27 and first and second longitudinal notches 34 and 36, respectively, positioned such that the apex of notches 34 and 36 are aligned with longitudinal center line 27 and thus the longitudinal center of receptacle 24. It is understood that receptacle latitudinal and longitudinal center indicators 26 and 28 may comprise lines, notches, combinations thereof, or any other indicators that provide an identification of the latitudinal and longitudinal centers of receptacle 24 and, ultimately, the geometric center of receptacle 24.

Referring particularly to FIGS. 4 and 5, in operation, alignment apparatus 20 may be moved to a location along target sheet 1 where it is desired to punch (cut) an aperture from the target sheet. Punch 12 may be slid into receptacle 24 of alignment apparatus 20. Apparatus 20 along with punch 12 may be moved, aligned and positioned into the desired aperture location by aligning receptacle latitudinal and longitudinal center indicators 26 and 28 with target latitudinal and longitudinal center lines 2 and 3, respectively. As set forth above, target latitudinal and longitudinal center lines 2 and 3 identify the location of the geometric center of the aperture desired to be punched from target sheet 1. Once in the punch 12 and alignment apparatus 20 are in the desired position, die 14 may be positioned on the opposite side of target sheet 1 and punch 12. Draw stud 16 is threaded through die 14, a pilot hole 6 in target sheet 1, and punch 12, and then actuated to begin drawing the die through the target sheet to punch the aperture from the target sheet at the desired location. It is understood, that instead of punch 12 being placed within receptacle 24 of apparatus 20, die 24 may be placed within receptacle 24 (or both punch 12 and die 14 may be placed in separate alignment apparatuses) to assist in aligning the punch and die set in order to punch an aperture at the desired location along target sheet 1.

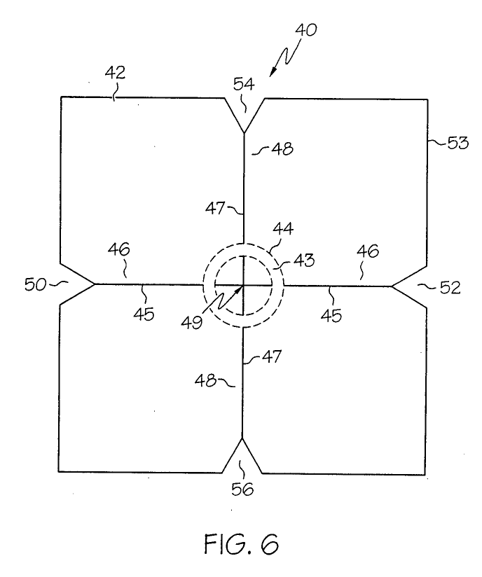

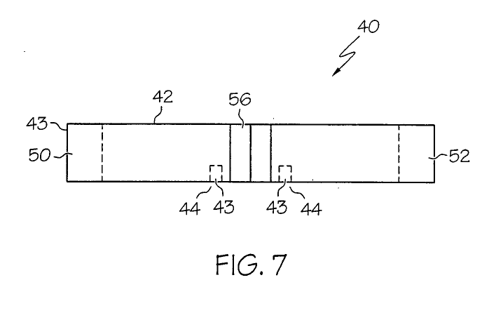

Referring to FIGS. 6 and 7, another exemplary embodiment of an alignment apparatus 40 is shown as generally including a body 42, a receptacle 44, a receptacle latitudinal center indicator 46, and a receptacle longitudinal center indicator 48. In the exemplary embodiment, receptacle 44 is configured to permit a conduit (e.g., an electrical conduit) to fit or slide into it. For example, as shown in FIGS. 6 and 7, receptacle 44 comprises an annular channel 43 that is partially disposed within body 42 such that a conduit may fit within channel 43.

Receptacle latitudinal center indicator 46 may comprise a line, notch, combinations thereof, or any other indicator capable of identifying the latitudinal center of receptacle 44. Similarly, receptacle longitudinal center indicator 48 may comprise a line, notch, combinations thereof, or any other indicator capable of identifying the longitudinal center of receptacle 44. As shown in FIG. 6, receptacle latitudinal center indicator 46 includes a latitudinal center line 45 and first and second latitudinal notches 50 and 52, wherein the apex of notches 50 and 52 are aligned with latitudinal center line 45. In addition, FIG. 6 shows that receptacle latitudinal center indicator 46 includes a longitudinal center line 47 perpendicular to latitudinal center line 45 and first and second longitudinal notches 54 and 56, wherein the apex of notches 54 and 56 are aligned with longitudinal center line 47. First and second latitudinal and longitudinal notches are disposed along a peripheral edge 53 of body 42.

In operation, the exemplary embodiment in FIGS. 6 and 7 may be used to assist in locating, aligning, and positioning an aperture to be punched within a target sheet such as a wall (e.g., bottom wall) of an electrical enclosure. For example, in constructing a facility (commercial building), an electrical enclosure may have to be installed, wherein it must align with pre-installed conduits that penetrate through the floor of the facility. Thus, to connect the conduits to the electrical enclosure, an apertures need to be punched into walls (e.g., the bottom wall) of the electrical enclosure that align (match up) with the conduits. To do this, measurements are typically attempted to be taken from a fixed item such as a wall of the facility to the geometric center of each conduit that will need to be connected to the enclosure.

Getting an exact measurement to the center of the conduit can be very difficult because the center is not visible, i.e., it is open space in the inside of the conduit, and thus the conduit's center location is typically estimated (“eye-balled”) by the person taking the measurement (e.g., an electrician). The present invention enables an improved measurement and location of the center and thus an improved alignment of the conduit(s) and the enclosure. To accomplish this, alignment apparatus 40 may be positioned onto the conduit such that the conduit slides into receptacle 44. Once positioned, a measurement from the nearest fixed item (e.g., a facility wall) to either receptive latitudinal center indicator 46 or receptacle longitudinal center indicator 48, whichever is in a parallel orientation to a planar surface of the fixed item (e.g., the facility wall's face) may be taken.

For example, a measurement may be taken from a first facility's wall and the receptacle latitudinal center indicator 46. This measurement will permit the distance from the first facility wall to the geometric center of the conduit to be determined and thus provide the distance from a first wall of the enclosure (wall located nearest to the first facility wall) to the center of the desired location for the required aperture in order to be aligned with this conduit. A second perpendicular measurement may be taken from a second fixed item (e.g., a second wall of the facility) to the receptacle longitudinal center indicator 48 that is perpendicular to the first measurement. This will give an improved, and possibly an exact, measurement and thus location of where the aperture needs to be punched along the bottom wall of the enclosure such that it aligns with the conduit.

Using the example set forth above, if additional apertures need to be punched from the enclosure to align with additional conduits, then while the apparatus 40 is still on the first conduit, a mark may be made on the first wall, perpendicular to the receptacle latitudinal center indicator 46. This may be accomplished by placing one side of a T-Square along the receptacle latitudinal center line 45 and then marking perpendicular location along the first wall. This mark identifies the location of the geometric center of the first conduit along the first wall. This process may then be repeated for a second conduit such that a second mark may be identified on the first wall, locating the geometric center of the second conduit. A measurement may then be taken by between the first mark and the second mark in order to get an exact measurement of the distance between the two conduits.

Another exemplary method to measure the distance between two conduits and thus the required distance needed between two apertures to be punched within an enclosure will be set forth below. A first alignment apparatus (e.g., alignment apparatus 40) may be positioned on a first conduit and a second alignment apparatus (e.g., alignment apparatus 40) such that one of the receptacle center indicators (either latitudinal 46 or longitudinal 48) of the first alignment apparatus is parallel to one of the receptacle center indicators (either latitudinal 46 or longitudinal 48) of the second alignment apparatus. A measurement may then be taken between the two parallel receptacle center indicators.

Accordingly, while some of the alternative embodiments of the present invention have been discussed specifically, other embodiments will be apparent or relatively easily developed by those of ordinary skill in the art. Accordingly, this invention is intended to embrace all alternatives, modifications and variations that have been discussed herein, and others that fall within the spirit and broad scope of the claims.

What is claimed is:

1. An apparatus for aligning a punch with a target area, comprising:
a body;
a receptacle disposed within the body and configured to receive a punch or die;
a receptacle latitudinal indicator disposed on the body such that it is aligned with the latitudinal center of the receptacle, wherein the receptacle latitudinal indicator is configured to identify the latitudinal center; and
a receptacle longitudinal indicator disposed on the body such that it is aligned with the longitudinal center of the receptacle, wherein the receptacle longitudinal indicator is configured to identify the longitudinal center.

2. The apparatus according to claim 1, wherein the receptacle latitudinal and longitudinal indicators are operable to align with respective target latitudinal and longitudinal indicators disposed on a substrate, and wherein an intersection of the respective target latitudinal and longitudinal indicators define the center of a target aperture to be punched within the substrate.

3. The apparatus according to claim 2, wherein the intersection of the respective target latitudinal and longitudinal indicators mark the center of an aperture to be cut out of the target substrate.

4. The apparatus according to claim 1, wherein the receptacle latitudinal indicator comprises:
a first receptacle latitudinal indicator; and
a second receptacle latitudinal indicator disposed on the body opposite the first receptacle latitudinal indicator;
wherein first and second receptacle latitudinal indicators are aligned with the latitudinal center of the receptacle.

5. The apparatus according to claim 1, wherein the receptacle longitudinal indicator comprises:
a first receptacle longitudinal indicator; and
a second receptacle longitudinal indicator disposed on the body opposite the first receptacle longitudinal indicator;
wherein first and second receptacle longitudinal indicators are aligned with the receptacle longitudinal center of the receptacle.

6. The apparatus according to claim 1, wherein the receptacle latitudinal and longitudinal indicators comprise cross hairs such that an intersection of the receptacle latitudinal and longitudinal indicators define the center of the receptacle.

7. The apparatus according to claim 1, wherein each of the receptacle latitudinal and longitudinal indicators comprise a notch disposed within the peripheral edge of the body to identify the respective receptacle latitudinal and longitudinal indicators.

8. An apparatus for aligning a punch with a target aperture location to be punched within a sheet, comprising:
a body;
a receptacle disposed within the body and configured to receive a punch or die;
a first receptacle indicator aligned with and indicating the latitudinal center of the receptacle; and
a second receptacle indicator aligned with and indicating the longitudinal center of the receptacle.

9. The apparatus according to claim 8, wherein the first and second receptacle indicators are operable to align with respective first and second target indicators disposed on a sheet defining the center of a target aperture to be punched within the sheet.

10. The apparatus according to claim 8, wherein an intersection of the first and second receptacle indicators define the center of the receptacle.

11. The apparatus according to claim 8, wherein the first and second receptacle indicators comprise a cross hair such that an intersection of the first and second receptacle indicators define the center of the receptacle.

12. The apparatus according to claim 8, wherein each of the first and second receptacle indicators comprise a notch disposed within the peripheral edge of the body aligned with and indicating the respective receptacle latitudinal and longitudinal centers.

13. An apparatus for determining the center of a conduit, comprising:
a body;
a receptacle disposed within the body and configured to receive an end of a conduit;
a receptacle latitudinal indicator disposed on the body such that it is aligned with the latitudinal center of the receptacle; and
a receptacle longitudinal indicator disposed on the body such that it is aligned with the longitudinal center of the receptacle;
wherein the receptacle latitudinal and longitudinal indicators are configured to identify the geometric center of a conduit received within the receptacle.

14. The apparatus according to claim 13, wherein an intersection of the receptacle latitudinal and longitudinal indicators define the center of the conduit.

15. The apparatus according to claim 13, wherein the receptacle latitudinal indicator comprises:
a first receptacle latitudinal indicator; and
a second receptacle latitudinal indicator disposed on the body opposite the first receptacle latitudinal indicator;
wherein first and second receptacle latitudinal indicators are aligned with the latitudinal center of the receptacle.

16. The apparatus according to claim 13, wherein the receptacle longitudinal indicator comprises:
a first receptacle longitudinal indicator; and
a second receptacle longitudinal indicator disposed on the body opposite the first receptacle longitudinal indicator;
wherein first and second receptacle longitudinal indicators are aligned with the receptacle longitudinal center of the receptacle.

17. The apparatus according to claim 13, wherein the receptacle latitudinal and longitudinal indicators comprise cross hairs such that an intersection of the receptacle latitudinal and longitudinal indicators define the center of the receptacle.

18. The apparatus according to claim 13, wherein each of the receptacle latitudinal and longitudinal indicators comprise a notch disposed within the peripheral edge of the body to identify the respective receptacle latitudinal and longitudinal indicators.

19. A method of using the apparatus according to claim 13, comprising:
placing the apparatus on a conduit such that an end of the conduit slides into the receptacle causing the intersection of the receptacle latitudinal and longitudinal indicators to be disposed at the center of the conduit; and
measuring from a first object to the receptacle latitudinal indicator to determine the distance that the center of the conduit is from the first object.

20. A method of using the apparatus according to claim 13, comprising:
placing the apparatus on a first conduit such that an end of the first conduit slides into the receptacle causing the intersection of the receptacle latitudinal and longitudinal indicators to be disposed at the center of the first conduit;
using the apparatus to indicate on a first object where the longitudinal center of the first conduit is located;
placing the apparatus on a second conduit such that an end of the second conduit slides into the receptacle causing the intersection of the receptacle latitudinal and longitudinal indicators to be disposed at the center of the second conduit;
using the apparatus to indicate on the first object where the longitudinal center of the second conduit is located; and
measuring the distance between the longitudinal centers of the first and second conduits.
